(19) United States
(12) Patent Application Publication
(10) Pub. No.: US 2026/0358307 A1
(43) Pub. Date: Nov. 12, 2026

(54) Tandem HPLC and NIR spectroscopy system and method for monitoring bioprocesses

(71) Applicant: Nirrin Technologies, Inc., Billerica, MA (US)

(72) Inventor: Bryan A. Hassell, Cambridge, MA (US)

(21) Appl. No.: 19/674,619

(22) Filed: May 12, 2026

Related U.S. Application Data
(60) Provisional application No. 63/804,174, filed on May 12, 2025.

(51) Int. Cl. G01N 30/74; G01N 30/86; G01N 30/88; G01N 30/02

(52) U.S. Cl. CPC G01N 30/74; G01N 30/8603; G01N 30/8693; G01N 30/88; G01N 2030/027; G01N 2030/8827; G01N 2030/8831

(57) ABSTRACT

An analytical system and method are provided for characterizing samples separated by a liquid chromatography system, particularly useful in biopharmaceutical applications. The system includes a liquid chromatography unit configured to separate analytes into discrete fractions based upon size, charge, hydrophobicity, affinity, or other chemical characteristics. Eluted fractions from the chromatography unit flow into an integrated spectroscopic detector system comprising a flow cell defining a sample detection region. The detection region is optically interrogated using a tunable semiconductor laser spectrometer operating within near-infrared (NIR), short-wavelength infrared (SWIR), or mid-infrared (MIR) spectral regions. The system accurately distinguishes and quantifies biomolecules, including differentiating monomers from high-molecular-weight protein aggregates, identifying molecular variants and impurities, and monitoring subtle structural or compositional changes. Modular and detachable flow cell designs facilitate maintenance, cleaning, sterilization, or replacement, ensuring robust, reproducible, and high-precision real-time analytical performance in biopharmaceutical manufacturing and research workflows.

### RELATED APPLICATIONS

This application claims the benefit under 35 USC 119(e) of U.S. Provisional Application No. 63/804,174, filed on May 12, 2025, which is incorporated herein by reference in its entirety.

### BACKGROUND OF THE INVENTION

High-Performance Liquid Chromatography (HPLC) is an essential analytical technique widely employed in biopharmaceutical and life sciences industries for separating, identifying, quantifying, and characterizing a wide variety of biomolecules and compounds. Over recent years, significant advancements have been achieved, driving improvements in speed, resolution, sensitivity, reproducibility, automation, and integration with complementary analytical technologies. These developments have established HPLC as an indispensable tool in drug discovery, development, quality control, stability testing, and regulatory compliance within biopharmaceutical manufacturing processes.

Ultra-High-Performance Liquid Chromatography (UHPLC), employing smaller particle sizes and higher operating pressures, represents a significant advancement over conventional HPLC. UHPLC systems provide faster analysis times, superior peak resolution, and improved sensitivity, substantially enhancing throughput and analytical precision. Additionally, the introduction of advanced stationary-phase technologies, including superficially porous (core-shell) particles and monolithic columns, further optimizes separation efficiency and speed, enabling the analysis of complex biomolecules such as monoclonal antibodies, peptides, oligonucleotides, and vaccine components with unprecedented detail.

Integral to HPLC technology are various detector systems that provide essential data for identifying and quantifying analytes post-separation. Commonly used detectors in biopharmaceutical and life sciences applications include ultraviolet/visible (UV/Vis), diode array detection (DAD), fluorescence detection (FLD), refractive index detection (RID), evaporative light scattering detection (ELSD), charged aerosol detection (CAD), mass spectrometry (MS), and electrochemical detection (ECD).

Among these detectors, optical-based HPLC detectors play a critical role due to their robustness, versatility, sensitivity, and wide applicability. Optical-based detectors primarily include UV/Vis detectors, diode array detectors (DAD), and fluorescence detectors (FLD).

UV/Vis detectors operate by measuring the absorbance of analytes at specific ultraviolet or visible wavelengths, typically within the range of 190 to 800 nm. They are widely employed due to their reliability, simplicity, and ease of use, particularly for compounds with strong UV absorption, such as proteins, peptides, nucleic acids, and small organic molecules. However, their effectiveness may be limited for analytes exhibiting weak or no UV absorbance.

Diode Array Detectors (DAD), also known as photodiode array detectors (PDA), significantly expand upon the capabilities of traditional UV/Vis detectors by simultaneously measuring absorbance across multiple wavelengths. This approach allows for rapid spectral data acquisition, enabling peak purity assessments, compound identification, and improved selectivity in complex mixtures. DADs are commonly employed in impurity profiling, stability testing, and detailed qualitative analyses of biopharmaceutical products.

Fluorescence detectors (FLD) measure the emission of fluorescent light from analytes upon excitation at specific wavelengths, offering exceptional sensitivity and selectivity. This high sensitivity makes fluorescence detection particularly valuable for trace-level quantification of naturally fluorescent compounds or analytes that can be fluorescently labeled, such as peptides, proteins, nucleic acids, and glycans. Fluorescence detection is particularly critical in analyses requiring low detection limits and high specificity, such as impurity characterization, biomarker discovery, and pharmacokinetic/pharmacodynamic (PK/PD) studies.

Collectively, these advancements in optical-based detection technologies have significantly contributed to the ability of HPLC to provide rapid, sensitive, and precise analytical results, thereby enhancing its critical role in the biopharmaceutical and life sciences industries.

At the same time, many processes in the chemical, biochemical, pharmaceutical, food, beverage and in other industries benefit from analysis by various optical spectroscopy approaches. Among these, probably the most common is absorption spectroscopy. Incident light excites electrons of the analyte from a low energy ground state into a high energy, excited state, and the energy can be absorbed by both non-bonding n-electrons and π-electrons within a molecular orbital. Absorption spectroscopy can be performed in the ultraviolet, visible, and/or infrared region, with analytes of varying material phases and composition being interrogated by specific wavelengths or wavelength bands of light. The resulting transmitted light is then used to resolve the absorbed spectra, to determine the analyte's or sample’s composition, temperature, pH and/or other intrinsic properties for applications ranging from medical diagnostics, pharmaceutical developments, food and beverage quality control, to list a few.

In U.S. Patent Application Publication No. 2019/0358632A1, Hassell et al. describe analyses of culture media using near infrared (NIR) spectroscopic techniques.

Applications of NIR-based techniques to measurements of samples in flowcells are described in U.S. Patent Application Publication No. 2020/0240902A1, to Hassell et al.

U.S. Patent No. 11,499,903 to Hassell et al. describes robust, hands-free, non-destructive, real-time NIR techniques for identifying and/or quantifying constituents in a given process, using an in-situ probe that can be inserted and/or maintained in a bioreactor.

Conducting measurements on static samples is described in International Publication No. WO 2024/102825, published on May 16, 2024. A clam shell apparatus for analyzing a static or flowing sample is disclosed in International Publication No. WO 2025/014928, published on Jan. 16, 2025. Both documents are incorporated herein by this reference in their entirety.

### SUMMARY OF THE INVENTION

The present invention relates generally to systems and methods for analyzing samples separated by liquid chromatography, particularly in the context of biopharmaceutical and life sciences applications. More specifically, the invention provides a novel analytical platform that integrates a liquid chromatography system with an advanced near-infrared (NIR) spectroscopy detector system to deliver enhanced sensitivity, specificity, and robustness in real-time detection, identification, and quantification of biomolecules and other analytes.

In embodiments, the invention includes a liquid chromatography such as a high-performance liquid chromatography (HPLC) system configured to separate a sample mixture into discrete fractions based upon physical and/or chemical characteristics. The separated fractions are subsequently directed into an in-line, integrated detection apparatus comprising a flow cell adapted for spectroscopic analysis. This integrated detection apparatus preferably utilizes tunable laser-based near-infrared (NIR) spectroscopy, probing molecular overtone and combination vibrations to identify and quantify analytes with a high degree of precision and accuracy.

In particular implementations, the chromatography system is operated in Size Exclusion Chromatography (SEC) mode, providing effective separation of biomolecules according to their molecular size and weight. The fractions eluted from the SEC system pass through the flow cell, wherein an NIR spectroscopic analysis is performed. The NIR detector system is configured to differentiate between monomeric species and high-molecular-weight (HMW) protein aggregates, overcoming significant limitations inherent in conventional chromatography methods that rely solely on UV absorption detection.

Other chromatography can be used, however, such as UHPLC, FPLC, low-pressure chromatography, preparative chromatography, process chromatography, microfluidic LC, nano-LC, mixed-mode chromatography, and two-dimensional LC.

In further embodiments, the chromatography system may operate in other modes, such as Ion Exchange Chromatography (IEX), Reversed-Phase Chromatography (RPC), Hydrophobic Interaction Chromatography (HIC), or Affinity Chromatography (AC), each providing distinct mechanisms of separation tailored to particular classes of analytes or characterization goals. Integration with the NIR detection system provides real-time spectral analysis of eluted fractions from these modes, substantially improving analytical specificity and enabling identification of molecular variants, structural differences, impurities, and post-translational modifications that might otherwise remain undetected.

According to various aspects of the invention, the NIR detection system comprises a flow cell featuring a defined sample detection region configured for optical interrogation by a tunable semiconductor laser. The laser system typically operates at wavelengths within the near-infrared to short-wavelength infrared (NIR-SWIR) spectral region (approximately 780 nm to 3000 nm) or in the mid-infrared (MIR) region (approximately 3.5 μm to 10 μm). The tunable laser spectrometer preferably incorporates polarization management and optical reference mechanisms, enabling precise wavelength and power referencing, thus significantly improving accuracy and reducing interference arising from polarization-induced variability and fiber-induced artifacts.

Advantageously, the invention provides robust orthogonal analysis capabilities, reducing the need for extensive method optimization or specialized assays commonly required in traditional chromatographic workflows. The system can reliably distinguish co-eluting analytes, precisely quantify impurities, characterize subtle formulation differences, and confirm analyte identity and purity in real-time. Additionally, the modular construction and detachable flow cell design facilitate easy maintenance, cleaning, sterilization, or replacement, providing convenience and reliability for repeated and continuous use in rigorous manufacturing environments.

Overall, the invention delivers a comprehensive, integrated analytical platform combining advanced liquid chromatography techniques with high-resolution NIR spectroscopy detection. This approach significantly improves analytical performance, reduces method development complexity, and provides powerful real-time monitoring and quantification capabilities that are critical to quality control, regulatory compliance, and ensuring the safety and efficacy of biopharmaceutical products.

According to one aspect, a method is provided for analyzing a sample. The method comprises introducing the sample into a liquid chromatography system and separating constituents of the sample by the liquid chromatography system to produce an eluate comprising temporally separated constituents. At least a portion of the eluate is directed through a flow cell of a near-infrared spectroscopic detector, the flow cell defining a sample detection region. The sample detection region is interrogated with optical radiation comprising one or more wavelengths in a near-infrared spectral region, and optical radiation that has interacted with the eluate in the sample detection region is detected. Near-infrared spectral data is generated for the eluate. The near-infrared spectral data is associated with a chromatographic coordinate of the liquid chromatography system, and at least one constituent of the sample is identified or quantified based on the near-infrared spectral data and the chromatographic coordinate.

In some embodiments, the chromatographic coordinate comprises at least one of a retention time, an elution volume, a fraction number, a column volume, or a chromatographic peak. In this manner, the method can generate a chromatographic-spectral data set in which spectral information from the near-infrared spectroscopic detector is indexed to separation information from the liquid chromatography system. The constituent identification or quantification can therefore be based on both elution behavior and near-infrared spectral response, rather than on chromatography or spectroscopy alone.

In some embodiments, the liquid chromatography system is operated in a chromatography mode selected from size exclusion chromatography, ion exchange chromatography, reversed-phase chromatography, hydrophobic interaction chromatography, affinity chromatography, mixed-mode chromatography, hydrophilic interaction chromatography, normal-phase chromatography, and combinations thereof. The liquid chromatography system can be an analytical, preparative, process, at-line, on-line, in-line, or off-line chromatography system. In some embodiments, the liquid chromatography system comprises a high-performance liquid chromatography system or an ultra-high-performance liquid chromatography system.

In some embodiments, generating the near-infrared spectral data comprises comparing the detected optical radiation with a reference signal to compensate for optical power variation during interrogation of the sample detection region. The reference signal can be produced by a reference photodetector that detects a reference portion of the optical radiation. In some embodiments, a beam splitter splits the optical radiation into a sample beam directed through the sample detection region and a reference beam directed to the reference photodetector.

In some embodiments, the optical radiation is generated by a tunable laser, including a tunable semiconductor laser, that sweeps across a spectral band. The spectral band can be within a range of about 780 nm to about 2500 nm. In particular embodiments, the spectral band is within a range of about 1350 nm to about 1800 nm or within a range of about 2050 nm to about 2400 nm.

In some embodiments, identifying or quantifying the at least one constituent comprises comparing the near-infrared spectral data with at least one of a calibration library, a spectral library, a chemometric model, a classification model, or a regression model. The comparison can be performed using near-infrared spectral variables alone or using near-infrared spectral variables together with chromatographic separation information, including retention time, elution volume, fraction number, column volume, peak position, peak area, peak height, peak width, or peak shape. The output can include an identity determination, concentration, amount, purity value, impurity level, aggregate level, variant level, classification result, similarity score, probability score, confidence value, or regression result.

In some embodiments, a signal from at least one additional detector or sensor associated with the liquid chromatography system or the flow cell is received and used with the near-infrared spectral data. The additional signal can comprise at least one of ultraviolet absorbance, visible absorbance, diode-array absorbance, fluorescence, refractive index, conductivity, pH, pressure, flow rate, temperature, gradient composition, or fraction-collector status. Such information can be used for peak detection, detector-delay correction, retention-time alignment, elution-volume alignment, baseline correction, mobile-phase compensation, gradient compensation, model selection, quality assessment, or analyte quantification.

In some embodiments, the liquid chromatography system is operated in size exclusion chromatography mode, and identifying or quantifying the at least one constituent comprises distinguishing a monomeric biomolecule from an aggregate or high-molecular-weight species. The biomolecule can comprise a protein, antibody, monoclonal antibody, peptide, oligonucleotide, enzyme, or vaccine component. In other embodiments, the controller identifies or quantifies at least one of a charge variant, hydrophobic variant, conformational variant, post-translationally modified form, impurity, degradation product, or contaminant.

In some embodiments, the method further comprises outputting an analytical result. The analytical result can be used for reporting, storing, transmitting, displaying, or otherwise providing information concerning the identity, amount, concentration, purity, impurity level, aggregate level, or composition of one or more constituents in the eluate. In optional process-control embodiments, the analytical result can be used to control at least one of the liquid chromatography system, a valve, a fraction collector, a flow rate, a gradient, a stopped-flow acquisition, fraction pooling, fraction rejection, or a bioprocess operation. These control functions are optional uses of the analytical result and are not required for performing the combined liquid chromatography and near-infrared spectroscopic analysis.

According to another aspect, a method is provided for monitoring a bioprocess. The method comprises obtaining a sample from a bioprocess vessel, process line, harvest stream, formulation vessel, or autosampler. Constituents of the sample are separated by liquid chromatography, and eluate from the liquid chromatography is flowed through a near-infrared spectroscopic flow cell. Near-infrared spectra are acquired from the eluate during or after the chromatographic separation. A process-related attribute of the sample is determined from the near-infrared spectra, and the process-related attribute is output for use in monitoring or controlling the bioprocess.

The process-related attribute can include, for example, product identity, product concentration, protein concentration, total protein amount, monomer level, aggregate level, high-molecular-weight species level, low-molecular-weight fragment level, impurity concentration, variant distribution, degradation level, nutrient concentration, metabolite concentration, excipient concentration, product purity, or another critical quality attribute or process attribute. The output can be provided to an operator interface, data system, laboratory information management system, manufacturing execution system, process controller, or other system used in bioprocess monitoring or control.

According to another aspect, an analytical system comprises a liquid chromatography system configured to separate constituents of a sample and produce an eluate. A near-infrared spectroscopic detector is in fluid communication with the liquid chromatography system. The near-infrared spectroscopic detector comprises a flow cell defining a sample detection region configured to receive at least a portion of the eluate, a light source configured to direct optical radiation comprising one or more near-infrared wavelengths through the sample detection region, and a sample detector configured to detect optical radiation that has interacted with the eluate in the sample detection region. A controller is configured to generate near-infrared spectral data from a signal of the sample detector and to identify or quantify at least one constituent of the sample based on the near-infrared spectral data and chromatographic separation information from the liquid chromatography system.

In some embodiments of the analytical system, the liquid chromatography system is configured to perform at least one of size exclusion chromatography, ion exchange chromatography, reversed-phase chromatography, hydrophobic interaction chromatography, affinity chromatography, mixed-mode chromatography, hydrophilic interaction chromatography, or normal-phase chromatography. In some embodiments, the liquid chromatography system comprises a high-performance liquid chromatography system or an ultra-high-performance liquid chromatography system.

In some embodiments of the analytical system, the light source comprises a tunable semiconductor laser configured to sweep through a spectral band within about 780 nm to about 2500 nm. In particular embodiments, the tunable semiconductor laser is configured to sweep through a spectral band within about 1350 nm to about 1800 nm or within about 2050 nm to about 2400 nm. In some embodiments, the near-infrared spectroscopic detector further comprises a beam splitter and a reference photodetector configured to detect a reference beam split from the optical radiation.

In some embodiments of the analytical system, the controller is configured to generate a chromatographic-spectral data set comprising near-infrared spectral data indexed to at least one of retention time, elution volume, fraction number, column volume, or chromatographic peak. The controller can compare the near-infrared spectral data with at least one of a calibration library, a spectral library, a chemometric model, a classification model, or a regression model. The controller can thereby identify or quantify at least one constituent of the sample based on the combined chromatographic and spectral information.

In some embodiments of the analytical system, the controller is configured to distinguish a monomeric biomolecule from an aggregate or high-molecular-weight species after size exclusion chromatography. In some embodiments, the controller is configured to identify or quantify at least one of a charge variant, hydrophobic variant, conformational variant, post-translationally modified form, impurity, degradation product, or contaminant. In some embodiments, the flow cell comprises an input optical element and an output optical element that define the sample detection region therebetween.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A-1D are perspective views of the flow cell according to one embodiment of the invention;

FIG. 1E is a cross-sectional view of the flow cell of FIGS. 1A-D, showing the flow path through the flow cell;

FIG. 1F is another cross-sectional view of the flow cell of FIGS. 1A-D, showing optical elements supporting light transmission and defining a sample detection region;

FIG. 2A is a side perspective view showing rods forming a sample detection region;

FIG. 2B is a side perspective view of a cross-section showing the rods of FIG. 4A rotated from each other by an angle of 90 degrees (º) around the longitudinal axis;

FIG. 3A is a schematic diagram of a light beam traveling through rods constructed and orientated as shown in FIGS. 4A and 4B;

FIG. 3B is a graph showing the absence of overlap between the main beam and a secondary beam obtained using the rods constructed and oriented as shown in FIGS. 4A and 4B;

FIG. 3C is a plot of the effective etalon strength with reflection through water as a function of the angle between beams θ;

FIG. 4A is a perspective view of a module including a flow cell, according to one embodiment of the invention;

FIG. 4B is a perspective view of a module in which the flowcell has been removed from the module body;

FIG. 5A is a schematic diagram of tandem HPLC and NIR spectroscopy system and method for monitoring bioprocesses including the module of FIGS. 4A and 4B, according to one embodiment of the invention and a chromatography system;

FIG. 5B is a schematic diagram of the system of FIG. 5A, showing module components according to one embodiment of the invention; and

FIG. 6 is a flow diagram showing a method for analyzing a sample using a liquid chromatography system 300 in tandem with a near-infrared spectroscopy detector system 70, according to one embodiment of the invention.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term "and/or" includes any and all combinations of one or more of the associated listed items. Also, all conjunctions used are to be understood in the most inclusive sense possible. Thus, the word "or" should be understood as having the definition of a logical "or" rather than that of a logical "exclusive or" unless the context clearly necessitates otherwise. Further, the singular forms and the articles "a", "an" and "the" are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention generally relates to approaches for detecting and often quantifying compounds (analytes) present in a sample produced by a liquid chromatography system. The sample can be first obtained from a vessel, a bioreactor, or a mixing tank, for example, and then separated into components by the liquid chromatography system. Materials that can be investigated include but are not limited to components in culture media, nutrients, metabolites, enzymes, hormones, cytokines, proteins, and so forth. In embodiments, the apparatus and method described herein find applications in protein, e.g., mAb, manufacturing.

Many of the techniques described herein rely on spectroscopic approaches for determining the spectral response of sample analytes separated by the liquid chromatography system. In embodiments, samples are analyzed by absorption spectroscopy in the ultraviolet (UV), visible, or infrared (IR) region of the electromagnetic spectrum.

Of particular interest is spectroscopy that covers the near infrared (0.75–1.4 μm, NIR), short-wavelength infrared (1.4–3 μm, SWIR), mid-wavelength infrared (3–8 μm, MWIR), long-wavelength infrared (8–15 μm, LWIR), and the far infrared (15–1000 μm, FIR) of the spectrum. In examples, the method and system described herein are operated in the NIR through MIR, at a wavelength is within a range of from about 1350 to about 1800 nanometers (nm) or within a range from about 2050 to about 2400 nm. For MIR analyses the wavelength can be within a range from about 3.5 to about 10 microns.

Probing molecular overtone and combination vibrations, NIR-SWIR spectroscopy covers a region of from 780 nanometer (nm) to 2500 nm of the electromagnetic spectrum. In a shorthand approach, this region between 780 nm to 2500 nm can be simply referred to by the abbreviation “NIR”. An overview of NIR spectroscopy can be found, for example, in an article by A.M.C. Davies in “An Introduction to Near Infrared (NIR) Spectroscopy”, www.impublications.com/content/introduction-near-infrared-nir-spectroscopy. See also, Cervera, A. E., Petersen, N., Lantz, A. E., Larsen, A. & Gernaey, K. V. “Application of near-infrared spectroscopy for monitoring and control of cell culture and fermentation”, Biotechnol. Prog. 25, 1561–1581 (2009); and Roggo Y, et al., “A review of near infrared spectroscopy and chemometrics in pharmaceutical technologies”, Journal of Pharmaceutical and Biomedical Analysis, Volume 44, Issue 3, 2007.

For many applications, the light employed to carry out the sample analysis is generated by a tunable laser, which can be part of a laser spectrometer.

Tunable laser spectrometers will typically have a wavelength reference and a power reference. The wavelength reference allows the device to track its wavelength sweep through the tunable laser’s spectral scan band. The power reference detects the instantaneous power during the sweep so that any variance in the power can be compensated to accurately resolve the absorption spectra of the material of interest.

Other embodiments employ broadband sources in combination with bandpass filters or gratings. In addition, Fourier transform infrared (FTIR) spectrometers are still another option.

In some implementations, the wavelength of the light generated by the laser is within a region of from about 1350 to about 1800 nm, such as from about 1350 nm to about: 1400 nm, 1500 nm, 1600 nm, 1700 nm; or from about 1400 nm to about: 1500 nm, 1600 nm, 1700 nm or 1800 nm; or from about 1500 nm to about: 1600 nm, 1700 nm, 1800 nm; or from about 1600 nm to about: 1700 nm, 1800 nm; or from about 1700 nm to about 1800 nm. In other implementations, the wavelength employed is within a range of from about 2050 nm to about 2400 nm, such as from about 2050 nm to about: 2100 nm, 2200nm, 2300 nm; or from about 2100 nm to about: 2200 nm, 2300 nm, 2400 nm; or from about 2200 nm to about: 2300 nm, 2400 nm; or from about 2300 to about 2400 nm.

The instantaneous narrow band emission from the laser is typically less than 100 nm wide, Full Width at Half Max (FWHM). More often it is less than 50 nm wide and can be less than 25 nm wide or even less than 15 nm.

In the MIR region, the wavelength of the laser light can be within a range of from about 3.5 microns to about 10 microns, such as from about 3.5 microns to about: 4, 5, 6, 7, 8, 9 microns; or from about 4 microns to about 5, 6, 7, 8, 9, 10 microns; or from about 5 microns to about: 6, 7, 8, 9 10 microns; or from about 6 microns to about: 7, 8, 9, 10 microns; or from about 7 microns to about: 8, 9, 10 microns; or from about 8 microns to about: 9, 10 microns; or from about 9 to about 10 microns.

For some applications the tunable laser is optimized for a specific wavelength range which contains relevant, e.g., protein-critical chemical information (C-H, O-H, etc.). In one embodiment the tunable laser sweeps its wavelength in a spectral band including 2.3 micrometers in wavelength and sweeps through greater than 100 nanometers in wavelength. In one implementation, the laser sweeps through a spectral band extending from about 2.2 to 2.4 micrometers in wavelength.

Currently, the tunable laser has a semiconductor gain chip for amplification. The laser’s amplification is provided by a GaSb gain chip, in one example. Nevertheless, other material systems can be selected for the gain chip according to other examples. Common material systems are based on III-V semiconductor materials, including binary materials, such as GaN, GaAs, InP, GaSb, InAs, as well as ternary, quaternary, and pentenary alloys, such as GaAlAs, InGaN, InAlGaN, InGaP, AlGaAs, InGaAs, GaInNAs, GaInNAsSb, AlInGaAs, InGaAsP, AlGaAsSb, AlGaInAsSb, AlAsSb, InGaSb, InAsSb, and InGaAsSb and can be employed as the gain chip. Collectively, these material systems support operating wavelengths from about 400 nanometers (nm) to 2500 nm, including longer wavelength ranges extending into multiple micrometer wavelengths. Semiconductor quantum well, quantum cascade and quantum dot gain regions are typically used to obtain especially wide gain and spectral emission bandwidths, and support operation up to 250 µm in wavelength and can be employed as the gain chip. Quantum well layers may be purposely strained or unstrained depending on the exact materials and the desired wavelength coverage.

For high performance operations, all power variability must be fully compensated. And one source of power variability arises from the highly polarized nature of diode lasers. As a result, small changes in the polarization in conjunction with polarization dependent loss (PDL) in the different components such as lenses, beam splitters and detectors will result in an untracked power variability that will degrade the accuracy of the absorption spectra.

To ensure the polarization stability that is required to manage PDL, polarization maintaining fiber, such as polarization maintaining single mode optical (PANDA) fiber can be employed in conjunction with the tunable laser spectrometer. The use of polarization maintaining fiber, however, does not entirely solve the problem. The phenomenon of fiber polarization beat or PANDA ripple also arises because there is usually some power in the non-preferred polarization and this will beat with the power in the preferred polarization, causing power fluctuations. More generally, when two waves with different linear polarization states propagate in the birefringent polarization maintaining (PM) fiber, their phases will evolve differently. The difference in phase delay will be proportional to the fiber length.

Specific embodiments address at least some of these issues, as further described below. Details also can be found in US Patent Publication No. 2024/0117293 and International Publication WO 2024/076868, both published on Apr. 11, 2024, both being incorporated herein by this reference.

In some of its aspects, the present system features an arrangement that separates or de-couples the fluidics (conduits, channels, etc., that are used to direct a sample to and through a sample detection region) from elements (lenses, polarizer, beam splitter, detectors, fiber optics, etc.) used to analyze the sample.

Embodiments involve an in-line flow cell 11 that can be integrated into a flow arrangement downstream of a liquid chromatography separation element. For example, a sample can be obtained from a vessel, bioreactor, mixing vessel, process line, autosampler, or other source, introduced into a liquid chromatography system 300, separated by one or more chromatography columns or other separation media, and then directed through flow cell 11 for optical analysis by NIR detector system 70. The eluate need not be returned to the liquid chromatography system and need not be automatically fractionated. Rather, after passing through flow cell 11, the eluate can be directed to waste, to a collection vessel, to a fraction collector, to another detector, to a downstream process unit, or to another suitable destination. The in-line flow cell therefore supports post-separation spectroscopic characterization of a chromatographic eluate, regardless of whether the eluate is later collected, pooled, diverted, discarded, or further processed.

The flow cell can be made from a metal, stainless steel, for instance, or a suitable plastic material. A detachable design ensures that the flow cell can be inserted into a flowing arrangement and/or can be removed for disposal or for cleaning.

For repeated use, detaching the flow cell for autoclaving (an approach particularly well suited for stainless steel construction) or gamma irradiation (for plastic flow cells) ensures a sterile sample flow pathway. A detachable design is also compatible with disposable, e.g., single use flow cells, which can be pre-sterilized (for a sterile sample flow pathway) and discarded at the end of a given experiment.

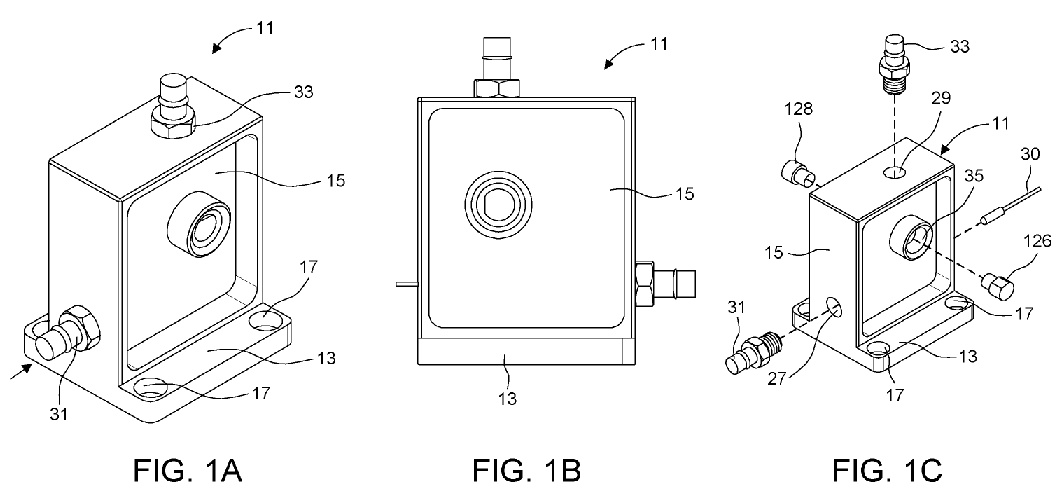

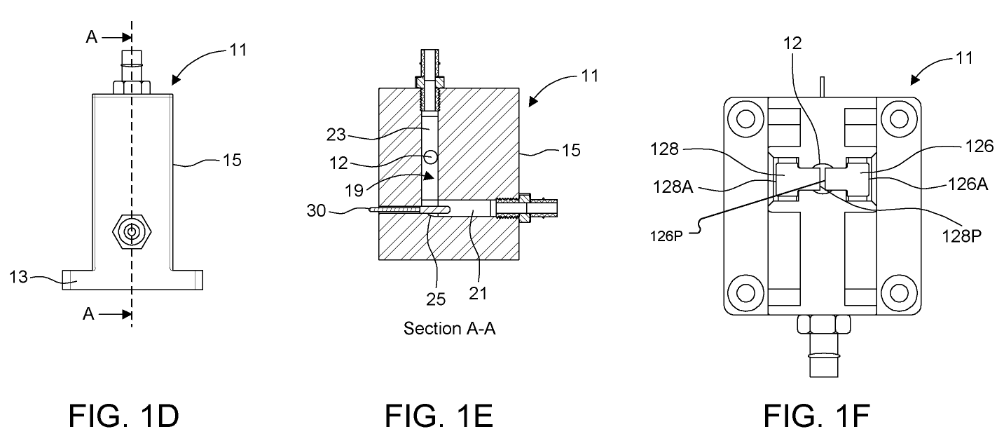

Shown in FIGS. 1A, 1B, 1C, 1D, 1E and 1F is flow cell 11 having base 13 and flow cell body 15. Base 13 can be mounted into a module (further described below), using screws 17 or other suitable attachments.

Flow cell body 15 defines a flow path supported, for instance by conduit or channel 19. This channel can be formed by a technique that can be selected by considering the flow cell material, flow cell dimensions and/or other criteria. For example, a channel can be formed in a plastic flow cell by constructing the flow cell using 3D printing. In a metal flow cell body, channel 19 can be formed by laser or plasma machining or other suitable techniques. More than one technique can be employed to produce different sections of the channel.

As seen in FIG. 1E, channel 19 includes segments 21 and 23, angled (e.g., by 90º) with respect to each other at elbow 25. Openings 27 and 29, optionally provided with fittings, are configured to receive connectors for the in-line mounting of the flow cell into a flowing arrangement. In one implementation, connectors 31 and 33 are barbed connectors.

The angled geometry of channel 19 can be combined with a preferred flow direction to mitigate bubbles. Thus, in embodiments, the sample enters at opening 27, proceeds through segment 21 and exits via segment 23 (at opening 29) as indicated by the arrow (FIG. 1A).

If desired, the flow cell can be provided with one or more devices for measuring sample parameters (pH, temperature, conductivity, flow rates, etc.), as illustrated by device 30 in FIGS. 1C and 1E. In examples, device 30 is or includes a thermistor, a pH sensor, a conductivity sensor and/or a flow meter. Such a device can be placed at other suitable points along segments 21 or 23, e.g., before or after elbow 25, and can be within or outside the flow cell body 15.

Opening 35 allows a light beam to enter the flow cell along a light pathway that is orthogonal to the flow path of the sample. An opening opposite opening 35 allows the light beam to exit the flow cell. Both entry and exit openings are fitted, respectively, with input rod 126 and output rod 128 (FIG. 1F), the two rods being made of a material transparent in the spectroscopic region of interest. In specific implementations, rods 126 and 128 are made from sapphire or quartz.

The innermost rod ends, namely transmission port 126P and detection port 128P, define sample gap or sample detection region 12. In embodiments, the sample detection region 12 is formed in segment 23 of channel 19 (see FIG. 1E, for example), after the sample has passed through elbow 25. This location registers less bubbles due to the bubble mitigation discussed above.

During operation, a light beam enters input rod 126 at port 126A, travels through the input rod, enters the sample gap 12 at transmission port 126P, traverses the sample gap, then enters detection rod 128 at detection port 128P. The distance between ports 126P and 128P represents the pathway traversed by the light beam during the optical sample analysis. Setting the sample gap traversed by the light beam can be realized by approaching or distancing the rods relative to each other. In specific implementations, one or both rods are provided with a mechanism that allows the translation of the rod. In many embodiments the light pathway (sample gap) does not vary (remains fixed) during a given spectroscopic measurement or even during successive measurements of a flowing sample.

The selected pathlength can have a value within a range of from about 0.010 millimeters (mm) to about 5 mm or, in some cases, to about 10 mm, such as, for example, within a range of from about 0.01 mm to about: 0.05 mm, 0.1 mm, 0.5 mm, 1 mm, 2 mm, 3 mm, 4 mm, 5 mm, 6 mm, 7 mm, 8 mm, 9 mm, 10 mm; or from about 0.05 mm to about: 0.1 mm, 0.5 mm, 1 mm, 2 mm, 3 mm, 4 mm, 5 mm, 6 mm, 7 mm, 8 mm, 9 mm, 10 mm; or from about 0.1 mm to about: 0.5 mm, 1 mm, 2 mm, 3 mm, 4 mm, 5 mm, 6 mm, 7 mm, 8 mm, 9 mm, 10 mm; or from about 0.5 mm to about: 1 mm, 2 mm, 3 mm, 4 mm, 5 mm, 6 mm, 7 mm, 8 mm, 9 mm, 10 mm; or from about 1 mm to about: 2 mm, 3 mm, 4 mm, 5 mm, 6 mm, 7 mm, 8 mm, 9 mm, 10 mm; or from about 2 mm to about: 3 mm, 4 mm, 5 mm, 6 mm, 7 mm, 8 mm, 9 mm, 10 mm; or from about 3 mm to about: 4 mm, 5 mm, 6 mm, 7 mm, 8 mm, 9 mm, 10 mm; or from about 4 mm to about: 5 mm, 6 mm, 7 mm, 8 mm, 9 mm, 10 mm; or from about 5 mm to about: 6 mm, 7 mm, 8 mm, 9 mm, 10 mm; or from about 6 mm to about: 7 mm, 8 mm, 9 mm, 10 mm; or from about 7 mm to about: 8 mm, 9 mm, 10 mm; or from about 8 mm to about: 9 mm, 10 mm; or from about 9 mm to about 10 mm.

One illustrative pathlength is about 5 mm. Another illustrative pathlength is 1 mm. For Mid-IR, measurements, the pathlengths can be reduced, to about 10 microns, for instance.

In specific implementations, the rods have a diameter within a range from about 2 to about 8 millimeter (mm), e.g., about 4 mm. This arrangement can allow a beam of between 0.5 and 3 mm in diameter, preferably about 1 mm, to progress through the rods and the sample in the sample gap 12. In many cases, both rods have the same diameter. In others, the rods have different diameters. Other rod dimensions can be selected.

In many optical arrangements, etalons are formed between parallel reflecting surfaces. For instance, surfaces will reflect due to the refraction index mismatch between air and the bulk material of the input rod 126. An index mismatch between the fluid in the detection sample region 12, the input rod 126 and the output rod 128 can occur as well. Another refraction index mismatch can occur when the light beam exits the output rod 128. Even if surfaces are antireflection coated, residual reflectivity can still be present.

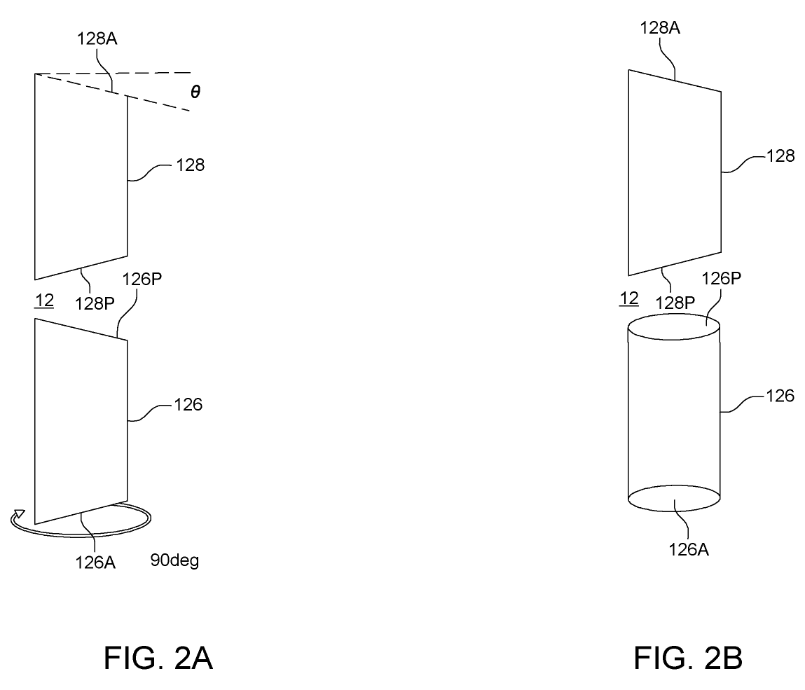

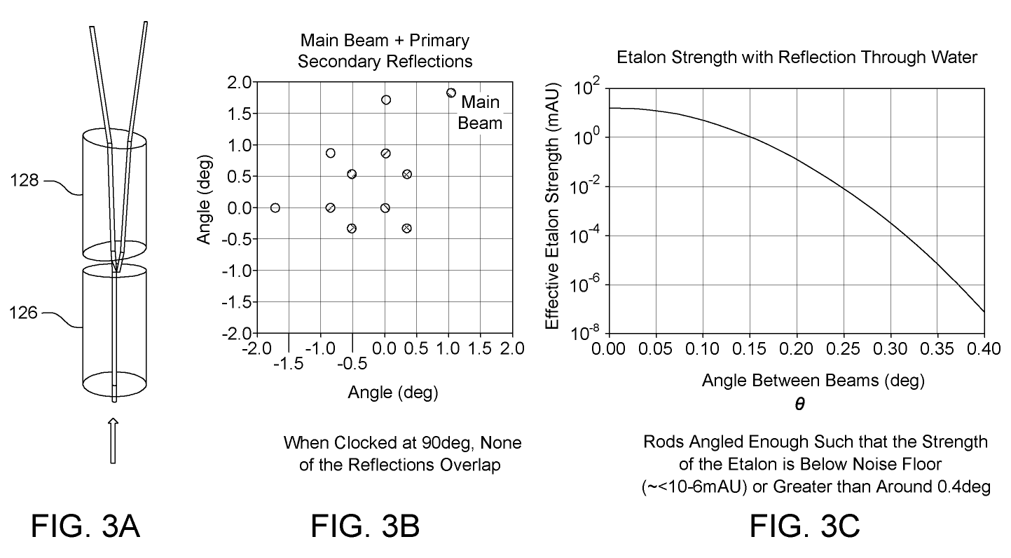

Some measures that can be taken to avoid or mitigate reflections/etalons are described with reference to FIGS. 2A, 2B and 3A.

Illustrated in FIG. 2A are input rod 126 and output rod 128, defining sample gap 12 between a transmission port 126P and a detection port 128P. Wedge angles θ are formed on ports 126A, 126P of the input rod 126, and, also, on ports 128P and 128A of the output rod 128, resulting in slanted or sloping wedged surfaces. Typically, the wedge angles θ are a few tenths of a degree, such as, for instance withing a range of from about 0.09 to about 0.6 degrees. In one example, angle θ (FIG. 2A) is 0.125 degrees. In further embodiments, the angles of the input rod 126 and the output rod 128 are rotated (see circular arrow in FIG. 2A) 90 degrees relative to each other, resulting in the orientation of FIG. 2B. In this example, the ports 128A, 128P of the output rod 128 are angled left to right in the plane of the figure. The ports 126A, 126P of the input rod 126 are angled fore and aft in the plane of the figure.

A schematic diagram of light traveling though input rod 126 then output rod 128, constructed and oriented as described above, is shown in FIG. 3A. When clocked at 90 degrees, none of the reflections overlap. This can be seen in FIG. 3B, showing no superposition (overlap) of the main beam (dark circles) and primary and secondary reflections (lighter circles). FIG. 3C presents the etalon strength with reflection through water. The rods are angled (angle θ) such that the strength of the etalon is below the noise floor, approximately less than about 10-6 mAU (milli-absorbance units) or greater than about 0.4 degrees.

Accordingly, the rods in sample cell 11 can incorporate geometric and orientation details that reduce or minimize reflections/etalons. Specifically, a rod can be angled with opposing wedges and a rod pair can include rods that are “clocked” 90 degrees relative to each other.

The flow cell can be enclosed in a module. The module design described herein separates the fluidic function provided via flow cell 11 from module components needed to conduct the sample analysis. Thus, a detachable flow cell that receives a sample flow can be removed, sterilized and reinstalled into the module, without disturbing other module components (components that do not support sample flow), such as detectors or optical elements, to name a few. These analysis or scanning elements are not exposed to the sample, do not need to be sterilized and can be kept out of the autoclave.

Thus, while the flow cell can be removed as often as needed, e.g., for disposal or sterilization, the module can remain in-line, e.g., for repeated measurements or series of measurements of the same or different samples, over any desired time period. Analysis or scanning elements (for propagating a light beam to and through sample detection region 12 (of the flow cell) and/or for detecting the light before and/or after its interaction with the sample in the sample detection region) are part of the module. Although they can be removed for trouble shooting, repair or replacements (e.g., when problems arise), they are not detachable in the sense in which the flow cell is detachable.

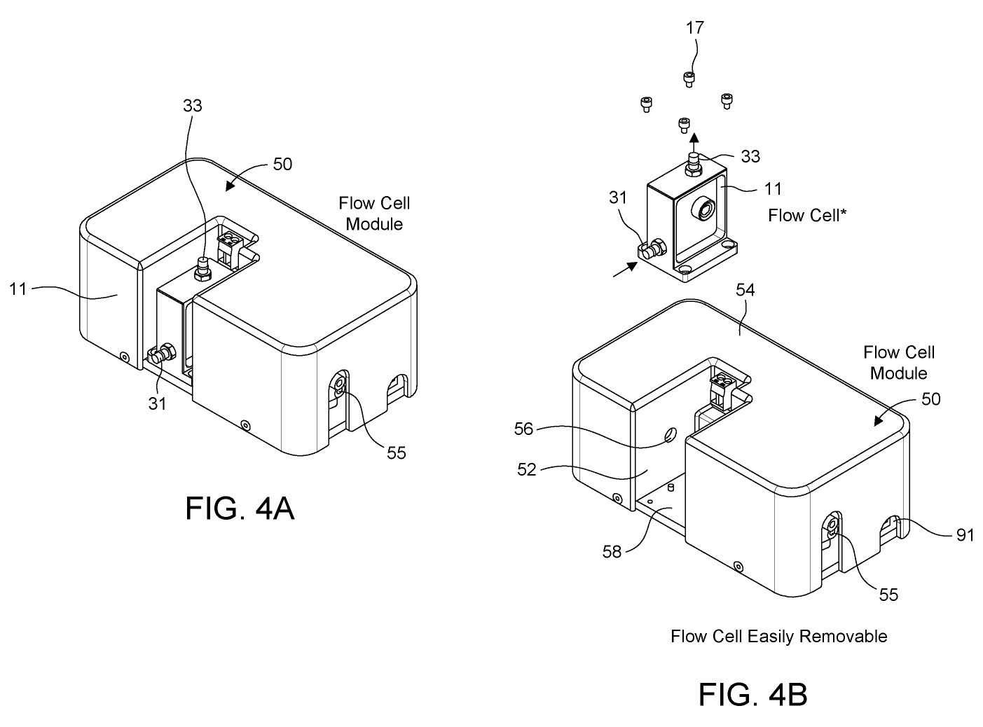

As shown in FIGS. 4A and 4B, module 50 includes a recessed volume 52, configured to receive flow cell 11. In practice, the flow cell can be removed while the sample flow through the module is stopped, at the end point of an operation, for example. The sterilized or a replacement flow cell can be (re)inserted into the module and the sample flow resumed. In some cases, a short interruption in flow permits the attachment of a temporary connector, a piece of tubing, for example, that can be used to replace the flow cell and maintain fluid communication through the module, albeit without measurement capabilities. Another interruption in flow permits the removal of the temporary connector and reinsertion of the flow cell.

For carrying out the sample analysis, opening 55 allows light to enter the module. After interacting with the sample in the flow cell, specifically in sample detection region 12, the light re-enters the module body 54 through opening 56. Electrical signal(s) can exit the module at output connector 91.

The module can be part of a system which can further include additional components such as, for instance a tunable laser (or another suitable light source), a controller, conduits for transmitting a light beam from an external light source to the module, electrical wires or cables for conveying an electrical signal from a detector to be analyzed, e.g., by the controller. In some implementations, the controller and the tunable laser can be part of a tunable laser spectrometer.

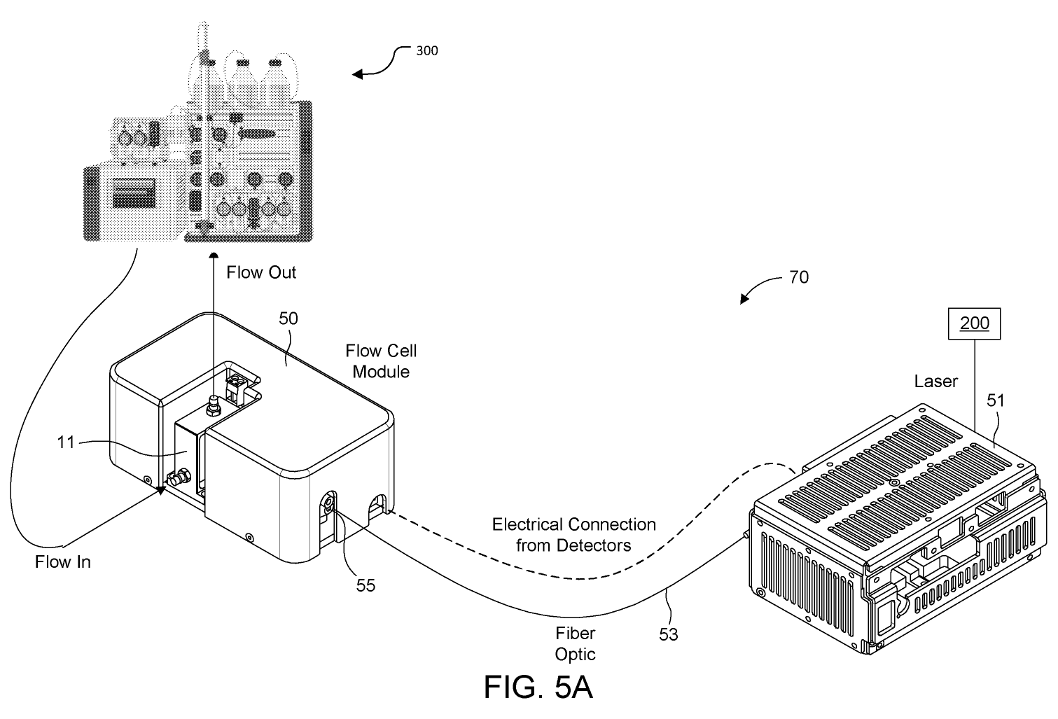

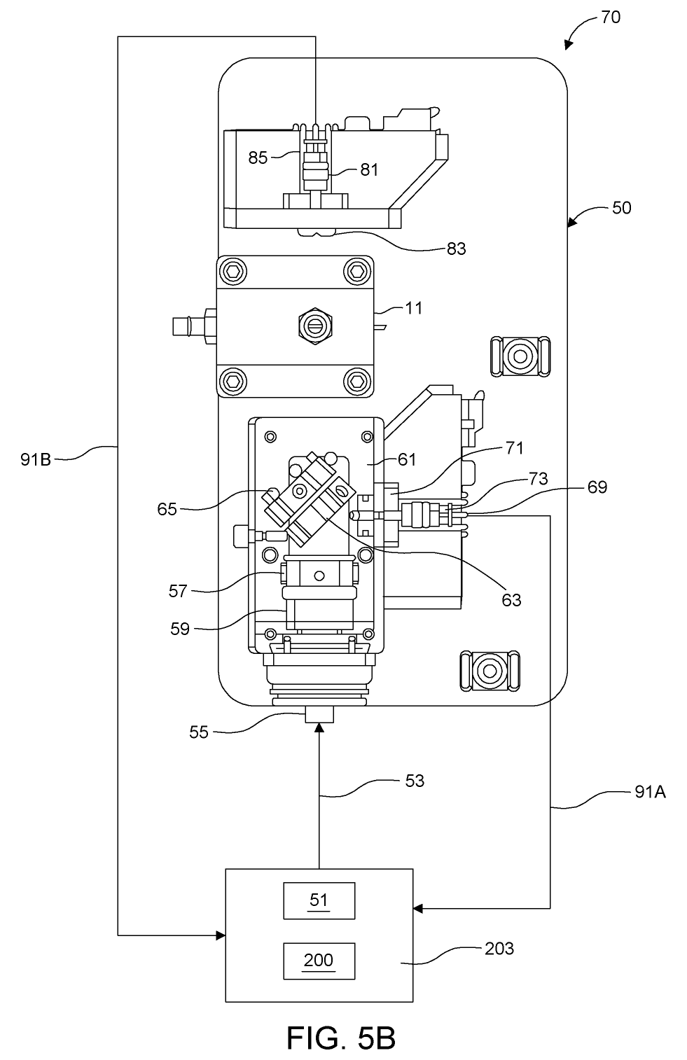

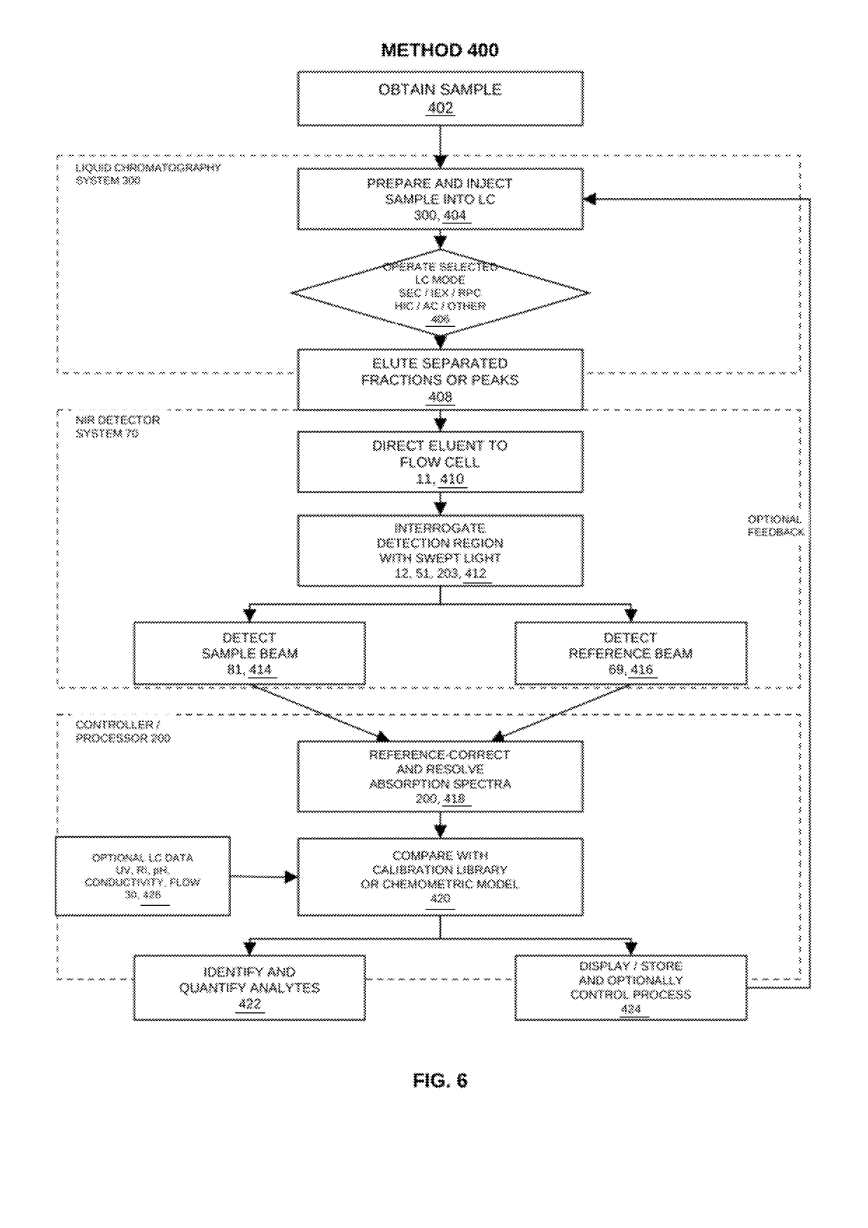

FIG. 5A shows a tandem liquid chromatography and NIR spectroscopy system for monitoring bioprocesses including chromatography 300 with a NIR detector system 70. FIG. 5B shows the details of the NIR detector system 70.

FIG. 5A shows a tandem liquid chromatography and NIR spectroscopy system 70 for monitoring, identifying, characterizing, or quantifying analytes in a separated sample stream. In the illustrated embodiment, liquid chromatography system 300 is shown schematically as a separation system that includes, or is coupled to, at least one chromatography column or separation unit. FIG. 5B shows details of NIR detector system 70 according to one embodiment. The depiction of liquid chromatography system 300 is functional and schematic. The liquid chromatography system can be implemented using any suitable analytical, preparative, process, at-line, on-line, in-line, or off-line chromatography arrangement and is not limited to any particular commercial instrument, vendor platform, pump architecture, column format, or detector configuration.

With respect to the NIR detector system 70, as shown in FIGS. 5A and 5B, an optical fiber arrangement such as fiber optics 53, which can be a PANDA fiber guides light from the laser to the module, specifically to fiberport 55. Fiberport 55 can be configured as a collimator for the light that exits the optical fiber patch cable. From the fiberport, the light pathway continues to polarizer 57 (for filtering and removing the light in the orthogonal polarization). A rotational mount 59 allows for the rotation of polarizer 57 in a plane that is orthogonal to bench 61 and orthogonal to the optical axis of the beam exiting from the fiber. In some implementations, mount 59 provides fine rotational adjustment of the polarizer 57 so that it can be aligned to the preferred polarization axis of the PANDA fiber.

A beam splitter (see, e.g., US 2024/0117293 or WO 2024/076868, both being incorporated herein by this reference) includes a partially reflecting sapphire window 63, such as a wedge window, held on a pitch yaw mount 65 that secures the window 63 to the bench 61. The partially reflecting sapphire window 63 reflects a portion of the beam, referred to herein as a “reference” beam, to a “tap” photodetector and lens arrangement. This arrangement includes a ripple amplitude reference photodetector 69, such as an In-GaAs detector; focusing lens 71 couples the beam onto the active area of the ripple reference detector 69. In addition to holding the window 63, the pitch yaw mount 65 allows the adjustments of the free space beam reflected and transmitted through the sapphire window 63 so that the beam will propagate to strike the active area of the ripple reference detector 69.

The ripple detector is mounted to a head printed circuit board (PCB) 73, which includes a transimpedance amplifier to amplify the electrical response of the ripple reference detector. A thermistor can be provided on the head printed circuit board to allow for temperature compensation of the detector 69 and transimpedance amplifier. The response of the ripple reference photodetector can then be transmitted as an electrical signal to tunable laser spectrometer 203 (which can include controller 200 and tunable laser 51, e.g., FIG. 5B) via electrical connection 91A, in an electrical wiring harness arrangement, for example.

In addition to the reference beam, the beam splitter generates a second beam, referred to herein as an “input”, “sample”, “main” or “interrogation” beam. From partially reflecting sapphire window 63, the main beam pathway progresses towards flow cell 11 and passes through the sample detection region 12, defined, as described above (FIGS. 1E, 1F. 2A, 2B, 3A), by optical transmission port 126P and an opposed optical detection port 128P.

In embodiments, the module is configured to align the flow cell with other elements within the module to ensure that light intersects the sample in the sample detection region 12. In a simple approach, this can be accomplished by using screws 17 (FIGS. 1A, 1C, for example) to secure flow cell 11 to the module base 58, in recessed volume 52. The screws can hold the flow cell in position, while some tolerance can be provided by how the rods defining the sample gap 12 are aligned with the light beam. For increased precision, convenience, and/or insertion/removal ease, base 58 can be provided with a kinematic platform configured to receive and/or secure base 13 of flow cell 11. The platform can use a commercial or customized magnetic design to replace screws 17, for example. In one example, a kinematic base is used such as a Newport Kinematic Base, Magnetic, e.g., 25 mm Square, Metric Model: M-BK-1A is used. This device includes a bottom plate that is secured to the base 58. The top plate is secured to the underside of the base 13 of flow cell 11. The kinematic base enables mounting, removal and replacement of the flow cell with high repeatability. The base includes three polished steel balls in the bottom plate to register with a hardened cone, groove, and flat in the top plate so the two plates relocate precisely.

Output rod 128 optically couples to sample (also referred to herein as “main”) photodetector 81, provided with lens 83. The electrical signal registered by the photodetector 81 can be transmitted to tunable laser spectrometer 203 via electrical connection 91B, e.g., in a wire harness arrangement. In one example, the photodetector is a dome lens TO-46 In-GaAs detector which can be electrically connected to a sample detector printed circuit board (PCB) 85. The detector PCB can include its own transimpedance amplifier for amplifying the detector response and transmitting that response to tunable laser spectrometer 203. A thermistor can be included on the detector PCB to detect the temperature allowing temperature offsets.

During operation, the tunable laser or tunable laser system sweeps its narrow band emission over some region of the electromagnetic spectrum such as the NIR and/or SWIR and/or MIR regions, or portions thereof. The swept wavelength light from the tunable laser 51 is coupled into the optical fiber patch cable 53, e.g., a PANDA optical fiber, to fiberport 55 of module 50.

The PANDA fiber optical fiber patch cable operates to reject modes, minimizing ripple. Short fiber patch cable lengths reduce or minimize losses. Polarizer 57 further removes modes and random polarization fluctuations and addresses polarization dependent loss in the optical components. The ripple reference detector can improve operations by addressing random power attenuation. Polarizing the light removes the risk of polarization dependent loss in the optical components. A portion of the polarized light is detected by the ripple reference photodetector 69. This ripple reference signal is transmitted back to the tunable laser spectrometer 203 (connection 91A in FIG. 5B) via a spectrometer electrical wiring harness, for example.

The remaining light travels toward and is coupled into input rod 126, exiting out at the optical transmission port 126P (FIGS. 1F, 2A, 2B). It then propagates through the sample detection region 12. The light leaves the sample detection region 12 through the optical detection port 128P and propagates through the output rod 128 (FIGS. 1F, 2A, 2B). It is detected by the sample photodetector 81 after being modulated by analytes in the sample detection region 12. The analytes will preferentially absorb some wavelengths relative to others.

In many cases, once it has entered the module, the light beam does not need to be confined to an optical fiber but can travel (from one element to another) in free space. Thus, in some implementations, light beams inside the module propagate without being guided by fiber optics. Other implementations employ a combination of fiber optics and free space light propagation, while in further implementations, light beams inside the module are guided by fiber optics.

According to the invention, NIR detector system 70 analyzes eluate after separation by liquid chromatography system 300. The liquid chromatography system 300 can include one or more pumps, sample introduction devices, valves, columns, separation membranes, cartridges, monoliths, stationary phases, detector modules, fraction collectors, waste lines, or process interfaces. In some embodiments, liquid chromatography system 300 can be represented as a generic separation unit or column positioned upstream of flow cell 11. The separation unit can perform size-based, charge-based, hydrophobicity-based, affinity-based, polarity-based, mixed-mode, or other liquid-phase separation. Thus, although particular commercial chromatography instruments can be used in some implementations, the invention is not limited to a specific instrument or to a specific physical layout of the upstream chromatography hardware. Nevertheless, in one implementation, the liquid chromatography system 300 is an AKTA Pure brand chromatography system sold by the Cytiva, Global Life Sciences Solutions USA LLC.

In more detail, in a current example, the liquid chromatography system 300 is a High-Performance Liquid Chromatography (HPLC) system. In one mode of operation, it performs Size-Exclusion Chromatography (SEC). This allows it to separate and profile components such as proteins, excipients, aggregates, and impurities. The liquid chromatography system 300 excels at physical separation. In one example, the liquid chromatography system 300 include an integrated as UV absorbance detector that operates at a fixed wavelength (e.g., 230 nm and/or 280 nm), conductivity detector, pH detector, and/or refractive index detector. The integrated detectors only provide only limited insight into the identity of the eluted species, however. This is particularly limiting in complex formulations or critical quality attribute monitoring, where co-eluting species or subtle formulation changes may go undetected.

The output of the liquid chromatography system 300 is then flowed to the liquid chromatography system NIR detector system 70 for further analysis. With a calibrated spectra library, the NIR detector system 70 yields quantitative, specific readouts on all the chemicals, not just general UV signals.

The principal analytical result of the tandem workflow is not merely an instruction to collect or pool fractions. Rather, the principal result is a combined chromatographic-spectral characterization of the separated sample. In this characterization, spectral information obtained by NIR detector system 70 is associated with chromatographic separation information from liquid chromatography system 300. For example, NIR absorbance, transmittance, spectral features, model scores, similarity scores, or predicted concentrations can be associated with retention time, elution volume, column volume, peak number, fraction number, valve state, gradient composition, or another chromatographic coordinate. The resulting data set can be used to identify, confirm, classify, characterize, or quantify one or more constituents in the eluate.

In this manner, liquid chromatography and NIR spectroscopy provide complementary analytical dimensions. The liquid chromatography system 300 provides separation information based on retention or elution behavior, while NIR detector system 70 provides molecular spectral information based on the optical response of the separated material. The controller 200 can use the combination of these two dimensions to make analyte calls that are more specific than those based on chromatography alone or NIR spectroscopy alone. For example, a constituent can be identified based on both its elution position and its NIR spectral signature, and a constituent can be quantified based on spectral response within a retention-time window, elution-volume window, peak region, chromatographic zone, or collected fraction.

The use of the term ‘fraction’ in connection with the separated material is not intended to require physical collection of a discrete fraction. In some embodiments, the separated material is analyzed as a continuously flowing eluate stream. In other embodiments, the separated material is analyzed as a chromatographic peak, peak shoulder, time slice, elution-volume slice, chromatographic zone, or physically collected fraction. Accordingly, references to analyzing an eluted fraction, separated fraction, or fraction of a sample should be understood to include analysis of separated material in a continuous eluate stream, whether or not the separated material is physically collected by a fraction collector.

With further characterization, NIR detector system 70 distinguishes monomers from HMW protein with NIR. Aggregation is difficult in the NIR, but this is solved with the addition of the liquid chromatography system 300 in this tandem method approach.

Additional benefits are provided including robustness against co-elution, real-time orthogonal readout without method development. The approach avoids the need for special assays to get good separation to “know” what the peaks represent. The NIR detector system 70 provides quantitation and/or just simple ID based on statistics and probabilities.

In operation, the combination of a liquid chromatography (e.g., HPLC) system 300 with a Near-Infrared (NIR) detector 70 significantly enhances analytical capabilities, particularly in distinguishing complex biomolecules such as monomers from high-molecular-weight (HMW) proteins. The liquid chromatography system initially separates complex mixtures into discrete fractions based on molecular size or chemical affinity. Following this physical separation, the NIR detector system analyzes the eluted fractions by probing their molecular vibrations, offering detailed compositional information beyond conventional UV-based detection.

Specifically, when operating in Size Exclusion Chromatography (SEC) mode, the HPLC system separates biomolecules based on their size and molecular weight. SEC utilizes porous beads within the chromatography column that differentially exclude molecules based on their size, with larger molecules eluting first and smaller molecules eluting later. The NIR detector integrated downstream provides precise molecular characterization of these separated fractions, offering insight into the composition of the eluate.

Additional useful chromatography modes suitable for this integrated HPLC-NIR setup include:
Ion Exchange Chromatography (IEX): Separates biomolecules based on charge interactions with the chromatography medium, allowing detailed characterization of charge variants and isoforms.
Reversed-Phase Chromatography (RPC): Separates analytes based on their hydrophobicity, particularly effective for peptide mapping and characterization of protein fragments or small molecule impurities.
Hydrophobic Interaction Chromatography (HIC): Separates biomolecules based on differences in hydrophobic interactions, effective in distinguishing protein conformations and monitoring post-translational modifications.
Affinity chromatography (AC) leverages specific biological interactions between analytes and immobilized ligands on the stationary phase, facilitating the selective enrichment and purification of target biomolecules, such as specific antibodies, antigens, or enzymes. Integration with NIR detection allows real-time confirmation and verification of the purified target, distinguishing it from non-specifically bound impurities and enabling detailed monitoring of the purification process efficiency and purity of eluted biomolecules.

By leveraging the tandem operation of SEC, IEX, RPC, HIC, or AC with NIR detection, it is possible to accurately distinguish monomeric species from aggregated proteins, identify isoforms, characterize post-translational modifications, and quantify trace-level impurities. This capability is particularly valuable in biopharmaceutical manufacturing, where comprehensive monitoring of product attributes is essential for ensuring product safety and efficacy.

The combined LC-NIR workflow can be used for orthogonal identification, compositional analysis, and quantitative characterization of eluents or fractions. In some embodiments, NIR detector system 70 confirms the identity of a chromatographic peak that has been separated by liquid chromatography system 300. In other embodiments, NIR detector system 70 determines the composition of an eluting peak, including the relative or absolute amount of one or more analytes, impurities, variants, excipients, buffer constituents, degradation products, or other constituents. In still other embodiments, controller 200 determines whether a chromatographic peak, peak region, or fraction contains a desired product, an undesired impurity, a co-eluting species, or a mixture of constituents. The result can be reported as an identity assignment, concentration, amount, purity value, impurity level, similarity score, probability score, classification result, regression result, or other quantitative or qualitative output.

Specifically, the controller 200, which can be part of the tunable laser spectrometer 203, monitors the response of the sample photodetector 81 as well as the ripple amplitude reference photodetector 69. The controller resolves the absorption spectra of the sample from liquid chromatography system 300 by monitoring the spectral scanning of the tunable laser 51 over its scan band relative to the time-response of the sample photodetector 81. Any noise associated with ripple or other sources from the optical fiber is compensated by the response from the ripple reference photodetector 69.

In some implementations, controller 200 uses the temperatures detected by the thermistor on the PCB associated with the sample detector 81 and the thermistor associated with the reference detector 69 to compensate for change in the response of the ripple reference photodetector 69 and the sample photodetector 81 and changes in the gain of the transimpedance amplifiers on the PCBs employed.

The results can be automatically analyzed and displayed on a suitable viewer.

The controller 200 can also monitor and/or adjust the sample flow through flow cell 11 (measured, for instance, by a flow meter (e.g., device 30 in FIGS. 1C, 1E). For example, monitoring a protein signal spectroscopically can be combined with monitoring the sample flow by control to the liquid chromatography system300. The measurements (spectroscopic signal and flow rate) can be integrated to provide “total” protein information, a parameter not typically available using current techniques or equipment.

In some cases, conductivity data, gathered e.g., by a conductivity sensor such as device 30 in FIGS. 1C and 1E, could be used to accurately subtract (for chemometrics) the salt gradient commonly used in Ion Exchange Chromatography.

Real-time orthogonal analysis provided by the NIR system addresses challenges associated with traditional UV detection, including limitations in specificity and the inability to detect subtle structural changes. Moreover, the integrated approach significantly improves analytical robustness against co-elution issues, enabling accurate quantification and reliable identification of analytes in complex mixtures without extensive method optimization. This integrated method provides a powerful analytical toolset capable of real-time monitoring and comprehensive analysis, essential for stringent regulatory compliance and maintaining high-quality standards in biopharmaceutical products.

FIG. 6 illustrates a method 400 for analyzing a sample using a liquid chromatography system 300 in tandem with NIR detector system 70. The illustrated sequence is exemplary. In different embodiments, one or more of the illustrated operations can be omitted, combined, repeated, performed in a different order, or performed concurrently, while still using liquid chromatography to separate components of a sample and NIR spectroscopy to analyze the separated components.

At step 402, a sample is obtained. The sample can be obtained from any suitable sample source, including a bioreactor, fermenter, vessel, mixing tank, harvest stream, formulation vessel, process line, vial, autosampler, fraction collector, or another source. The sample can be used without preparation or can be filtered, diluted, concentrated, buffer-exchanged, quenched, mixed with a reagent, or otherwise conditioned before chromatography.

At step 404, the sample is introduced into liquid chromatography system 300. The introduction can be performed through an injection valve, autosampler, sample loop, direct process connection, manual injection port, or another sample introduction device. The liquid chromatography system 300 can be an analytical, semi-preparative, preparative, process, at-line, on-line, in-line, or off-line chromatography system, including HPLC, UHPLC, FPLC, low-pressure chromatography, microfluidic chromatography, nano-liquid chromatography, or another liquid chromatography system.

At step 406, the liquid chromatography system 300 is operated in a selected chromatography mode. Suitable modes include size exclusion chromatography, ion exchange chromatography, reversed-phase chromatography, hydrophobic interaction chromatography, affinity chromatography, mixed-mode chromatography, hydrophilic interaction chromatography, normal-phase chromatography, chiral chromatography, or combinations of such modes.

At step 408, the liquid chromatography system 300 separates the sample into eluting bands, peaks, fractions, or chromatographic zones. The separated constituents of the original sample can be indexed by retention time, elution volume, fraction number, column volume, or another chromatographic coordinate. In some embodiments, the separated constituents are also monitored by one or more conventional liquid chromatography detectors, and data from such conventional detectors can be recorded with, aligned to, or combined with NIR spectral data.

At step 410, the separated eluate is directed from the liquid chromatography system 300 to NIR detector system 70. In the illustrated embodiment, the eluate passes through flow cell 11 and through sample detection region 12. The NIR detector system 70 can be positioned downstream of a chromatography column, downstream of one or more conventional detectors, upstream of a fraction collector, downstream of a fraction collector, in a side-stream or bypass path, or in another fluidic position suitable for analyzing separated sample material.

At step 412, the sample detection region 12 is optically interrogated. In one example, tunable laser 51 of tunable laser spectrometer 203 sweeps one or more wavelength bands in the NIR, SWIR, or MIR spectral regions, and the resulting interrogation beam is transmitted through the sample detection region 12. The optical interrogation can be continuous during elution or can be initiated in response to a chromatographic event, such as detection of a UV peak, detection of a conductivity transition, valve switching, entry of a selected retention-time window, or collection of a selected fraction.

At steps 414 and 416, optical signals are detected. At step 414, a sample beam that has interacted with the eluate is detected, for example by sample photodetector 81. At step 416, a reference beam is detected, for example by ripple amplitude reference photodetector 69. Controller 200 can use the sample-beam signal, reference-beam signal, wavelength information, power-reference information, detector-temperature information, flow information, and other available information to compensate for optical power variation, polarization effects, detector drift, baseline effects, mobile-phase effects, or other sources of measurement variation.

At step 418, controller 200 resolves one or more spectra associated with the eluting sample material. The resolved information can be represented as a spectral data set indexed by wavelength and by retention time, elution volume, fraction number, or another chromatographic coordinate. In some embodiments, controller 200 generates a two-dimensional chromatographic-spectral data matrix, an extracted NIR chromatogram at one or more wavelengths, a peak-specific spectrum, a fraction-specific spectrum, or a time-resolved spectral trace.

In some embodiments, at step 418, controller 200 generates more than an isolated NIR spectrum for a single sample point. Rather, controller 200 generates a chromatographic-spectral data set in which spectral information is associated with one or more chromatographic coordinates. The chromatographic-spectral data set can include absorbance, transmittance, reflectance, derivative absorbance, corrected absorbance, normalized spectral intensity, selected spectral features, scores, loadings, or other spectral variables as a function of wavelength and as a function of retention time, elution volume, column volume, fraction number, peak number, valve state, gradient composition, or another chromatography-related coordinate.

At step 418, controller 200 can generate a chromatographic-spectral data set rather than a single stand-alone NIR spectrum. The chromatographic-spectral data set can represent absorbance, corrected absorbance, transmittance, derivative absorbance, normalized intensity, selected spectral features, model scores, or predicted concentrations as a function of wavelength and as a function of a chromatographic coordinate. In one example, the data set is represented as A(λ,t), where λ represents wavelength and t represents retention time. In other examples, the data set is represented as A(λ,V), where V represents elution volume, or A(λ,F), where F represents a fraction identifier. This association allows the controller 200 to evaluate both the physical separation behavior of a constituent and the molecular spectral response of that constituent.

For example, controller 200 can generate a two-dimensional data matrix A(λ,t), A(λ,V), or A(λ,F), where λ represents wavelength, t represents retention time, V represents elution volume, and F represents fraction number. In other embodiments, the data set can be represented as a three-dimensional or higher-dimensional data structure that also includes temperature, pH, conductivity, flow rate, pressure, gradient composition, detector delay, or sample-source information. The chromatographic-spectral data set can be stored, displayed, transmitted, or processed as a spectral chromatogram, a wavelength-resolved chromatogram, a retention-time-resolved spectral map, a peak-specific spectrum, a fraction-specific spectrum, or a collection of extracted NIR chromatograms at selected wavelengths or spectral bands.

The association of spectral data with chromatographic coordinates permits controller 200 to evaluate both chromatographic separation behavior and molecular spectral response. Thus, a constituent can be identified, confirmed, or quantified based on a combination of its elution position and its NIR spectral signature. This combined chromatographic-spectral analysis can be useful when constituents partially co-elute, when a chromatographic peak contains multiple chemical species, when a UV or other conventional detector provides limited specificity, or when a constituent has weak or overlapping response in a conventional detector channel.

At step 420, controller 200 compares the resolved spectral information with a calibration library, reference spectral library, chemometric model, classification model, regression model, or other analytical model. The model can use NIR spectral features alone or can use NIR spectral features in combination with chromatography information such as retention time, peak area, peak shape, elution volume, UV absorbance, conductivity, pH, flow rate, pressure, temperature, or gradient composition.

In some embodiments, at step 420, controller 200 compares the chromatographic-spectral data set, a portion of the chromatographic-spectral data set, or spectral features derived from the data set with one or more reference libraries or analytical models. The reference libraries can include spectra of pure materials, formulated products, process intermediates, mobile phases, buffers, excipients, impurities, degradation products, standards, reference materials, calibration samples, lot-specific samples, or historical samples. The libraries can be specific to a chromatography mode, column chemistry, mobile phase, gradient, pathlength, temperature, sample class, product type, process step, or instrument configuration.

The analytical model can be a calibration model, classification model, regression model, similarity model, identity model, purity model, outlier model, or multivariate chemometric model. Suitable models include, without limitation, principal component analysis (PCA), partial least squares regression (PLS), classical least squares (CLS), multivariate curve resolution (MCR), soft independent modeling of class analogy (SIMCA), principal component regression, support vector machines, linear discriminant analysis, quadratic discriminant analysis, k-nearest-neighbor models, random forest models, neural-network models, Bayesian models, or combinations thereof. The model can use NIR spectral variables alone or can use NIR spectral variables together with retention time, elution volume, fraction number, UV absorbance, conductivity, pH, temperature, flow rate, pressure, gradient composition, peak area, peak height, peak width, or peak shape.

The calibration model can be generated using samples having known identity, concentration, purity, impurity level, aggregate level, charge-variant distribution, hydrophobic-variant distribution, formulation composition, degradation state, or another known attribute. The calibration samples can include purified standards, spiked standards, stressed samples, forced-degradation samples, process lots, development lots, production lots, reference lots, system suitability standards, or mixtures thereof. In some embodiments, separate models are maintained for different products, product families, chromatography modes, columns, gradients, mobile phases, instruments, or process stages.

Controller 200 can also perform model transfer, model standardization, model updating, or model maintenance. For example, controller 200 can use transfer standards, wavelength standards, intensity standards, reference samples, blank mobile-phase runs, or overlapping calibration samples to adapt a model from one NIR detector system 70 to another NIR detector system 70, from one flow cell 11 to another flow cell 11, or from one liquid chromatography system 300 to another liquid chromatography system 300. The model can be updated as additional lots, standards, impurities, degradation products, or process conditions are observed, while retaining historical calibration information. In some embodiments, controller 200 monitors model residuals, leverage, Mahalanobis distance, Q residuals, Hotelling’s T², prediction uncertainty, or another diagnostic to determine whether a sample is within the model domain.

The output of step 420 can include an identity match, class assignment, concentration, amount, purity, impurity level, aggregate level, variant level, similarity score, probability score, confidence value, prediction interval, pass/fail result, outlier flag, or recommendation for additional analysis. In some embodiments, controller 200 reports both a chromatographic result and a spectral result, such as a peak area together with a spectral identity score, or a fraction assignment together with a predicted concentration or purity.

At step 420, controller 200 can evaluate the chromatographic-spectral data set using reference spectra, calibration libraries, chemometric models, classification models, regression models, or similarity models. The model can use NIR spectral information alone or can use NIR spectral information in combination with retention time, elution volume, peak area, peak height, peak width, UV absorbance, conductivity, pH, flow rate, pressure, temperature, gradient composition, or other liquid chromatography information. In some embodiments, the controller 200 determines whether a constituent is consistent with an expected identity by comparing both the chromatographic coordinate and the NIR spectral signature with a reference data set. In other embodiments, the controller 200 quantitatively determines the amount or concentration of one or more constituents in a peak, chromatographic zone, or collected fraction.

At step 422, one or more analytes or sample constituents are identified, confirmed, or quantified. The identified or quantified constituents can include monomeric proteins, protein aggregates, high-molecular-weight species, low-molecular-weight fragments, charge variants, hydrophobic variants, conformational variants, glycoforms, post-translationally modified forms, excipients, buffer constituents, nutrients, metabolites, impurities, degradation products, or contaminants.

In some embodiments, at step 422, controller 200 identifies or quantifies a constituent using combined chromatographic and spectroscopic evidence. For example, a species can be assigned based on its retention time or elution volume and confirmed by its NIR spectral similarity to a reference spectrum. Conversely, a species having a known NIR spectral signature can be distinguished from another species that elutes at a similar retention time. This approach can improve analysis of partially resolved peaks, shoulders, co-eluting species, broad peaks, low-abundance impurities, or fractions that include more than one constituent.

The identification or quantification can be performed on a point-by-point basis during elution, on a peak-integrated basis after detection of a chromatographic peak, on a fraction-by-fraction basis during collection, or on a run-level basis after completion of the chromatographic method. In some embodiments, controller 200 integrates spectral signal over a selected wavelength range and over a selected retention-time or elution-volume window to determine total amount of a constituent. In other embodiments, controller 200 determines the relative abundance of multiple constituents by resolving overlapping spectral and chromatographic responses.

At step 422, the controller 200 can use the combined LC-NIR information to distinguish between species that would be ambiguous using a single analytical dimension. For example, two species having similar retention behavior can be distinguished based on differences in their NIR spectral signatures. Conversely, two species having similar NIR spectral features can be distinguished based on differences in retention time, elution volume, or other chromatographic behavior. This combined analysis can be used to support orthogonal identity confirmation, compositional analysis of partially resolved peaks, quantitation of constituents in complex mixtures, and characterization of eluents or fractions without requiring that every constituent be fully resolved by chromatography alone.

At step 424, the analytical result is displayed, stored, transmitted, or otherwise output. In some embodiments, controller 200 uses the result to adjust a chromatography method, trigger stop-flow spectral acquisition, control a valve, select or reject a fraction, pool fractions, adjust a gradient, modify a flow rate, initiate a cleaning step, or provide feedback to an upstream or downstream bioprocess operation.

Optional LC data 426 can be received and used with the NIR data. For example, UV/visible absorbance, diode-array spectra, fluorescence, refractive index, conductivity, pH, pressure, flow, temperature, gradient composition, or fraction-collector status can be used for retention-time alignment, detector-delay correction, mobile-phase subtraction, salt-gradient correction, baseline correction, peak triggering, model selection, or quality assessment.

In some embodiments, controller 200 aligns NIR spectral data with data from liquid chromatography system 300 or from one or more additional detectors. The alignment can include correction for fluidic delay between a chromatography column, a UV detector, a conductivity detector, a pH detector, a refractive-index detector, a fluorescence detector, a fraction collector, and flow cell 11 of NIR detector system 70. The correction can be based on tubing volume, flow rate, peak matching, injection time, valve-switching time, detector response time, or an experimentally determined offset. After alignment, the NIR spectral data can be fused with one or more chromatographic data channels to generate a combined data set for peak detection, peak deconvolution, analyte identification, quantification, fraction assignment, or quality assessment.

The data fusion can be performed at different levels. In one approach, raw or preprocessed NIR spectra are fused with raw or preprocessed chromatography signals. In another approach, extracted spectral features, absorbance values, peak areas, peak heights, retention times, elution volumes, fraction identifiers, or model scores are fused after separate processing. In still another approach, controller 200 uses the chromatography data to select a retention-time window, fraction, peak, model, library, baseline correction, or mobile-phase correction to be applied to the NIR data.

In some embodiments, optional LC data 426 is used by controller 200 to compensate for contributions from the mobile phase, gradient, buffer, solvent, salt, pH, conductivity, flow rate, pressure, temperature, or other non-analyte sources of variation. Such compensation can be useful because the eluate passing through sample detection region 12 can include analyte constituents as well as water, organic solvent, salts, buffers, additives, pH-adjusting agents, ion-pairing agents, detergents, excipients, or other mobile-phase components that have NIR spectral features or that alter the optical response of the sample.

Controller 200 can receive or derive mobile-phase information from liquid chromatography system 300, from device 30, from a conductivity sensor, pH sensor, temperature sensor, flow meter, pressure sensor, gradient-composition monitor, pump program, valve state, method file, or other source. The mobile-phase information can be used to subtract, normalize, model, or otherwise compensate for background spectral contributions. For example, in an ion exchange chromatography method, controller 200 can use conductivity data to compensate for a salt-gradient contribution to the NIR spectral data. In a reversed-phase chromatography method, controller 200 can use programmed or measured organic-solvent composition to compensate for changes in water, acetonitrile, methanol, isopropanol, trifluoroacetic acid, formic acid, or another mobile-phase component.

The compensation can be based on one or more blank runs, reference runs, mobile-phase spectra, buffer spectra, solvent spectra, gradient spectra, baseline models, internal standards, reference materials, or mathematical models. In some embodiments, controller 200 obtains a blank chromatographic-spectral data set using mobile phase without sample and subtracts or otherwise uses the blank data set during analysis of a sample chromatographic-spectral data set. In other embodiments, controller 200 applies baseline correction, derivative processing, scatter correction, standard normal variate correction, multiplicative scatter correction, extended multiplicative signal correction, normalization, smoothing, filtering, orthogonal signal correction, or another preprocessing operation before chemometric analysis.

The compensation can be static or dynamic. For example, controller 200 can apply a fixed reference spectrum for an isocratic method, a time-varying reference spectrum for a gradient method, or a sensor-dependent reference spectrum based on measured conductivity, pH, temperature, flow rate, or solvent composition. In some embodiments, controller 200 selects a compensation model based on the liquid chromatography mode, column type, mobile-phase recipe, gradient profile, analyte class, retention-time window, or fraction number.

At step 422, the controller 200 can use the combined LC-NIR information to distinguish between species that would be ambiguous using a single analytical dimension. For example, two species having similar retention behavior can be distinguished based on differences in their NIR spectral signatures. Conversely, two species having similar NIR spectral features can be distinguished based on differences in retention time, elution volume, or other chromatographic behavior. This combined analysis can be used to support orthogonal identity confirmation, compositional analysis of partially resolved peaks, quantitation of constituents in complex mixtures, and characterization of eluents or fractions without requiring that every constituent be fully resolved by chromatography alone.

In some embodiments, at step 424, controller 200 uses the analytical result to control liquid chromatography system 300, NIR detector system 70, a fraction collector, one or more valves, or another upstream or downstream process device. The control can be open-loop, closed-loop, supervisory, recipe-based, threshold-based, model-based, or operator-confirmed. The control action can be based on an analyte identity, concentration, purity, impurity level, aggregate level, variant level, spectral similarity score, probability score, chromatographic peak property, fraction property, or other analytical result.

For example, controller 200 can control fraction selection, fraction collection, fraction pooling, fraction rejection, or diversion of eluate to waste in or from a bioreactor. Fractions can be collected or pooled when the NIR spectral data confirms the identity or purity of a desired constituent, and fractions can be rejected when the NIR spectral data indicates an impurity, aggregate, degradation product, incorrect product, or off-specification composition. Controller 200 can also switch valves to route eluate to a fraction collector, waste container, secondary detector, secondary column, storage vessel, or downstream processing unit.

Controller 200 can also adjust operating parameters of liquid chromatography system 300. For example, controller 200 can modify a gradient, hold a gradient, change a flow rate, change a buffer composition, extend an elution step, initiate a wash step, initiate a regeneration step, trigger a stop-flow NIR acquisition, resume flow after spectral averaging, or initiate re-injection of a sample or fraction. In one embodiment, a UV signal, conductivity transition, retention-time window, or preliminary NIR result triggers a stopped-flow acquisition in flow cell 11 so that multiple NIR scans can be averaged for improved signal-to-noise ratio before the eluate is released or routed.

In some embodiments, controller 200 uses the result to provide feedback to an upstream or downstream bioprocess operation. Upstream feedback can include adjustment of a bioreactor feed rate, harvest timing, media addition, nutrient addition, induction timing, perfusion rate, or cell-culture control parameter. Downstream feedback can include adjustment of purification conditions, column loading, wash stringency, elution conditions, fraction pooling, formulation composition, concentration, buffer exchange, hold time, or release of a process intermediate. The feedback can be communicated to a process controller, manufacturing execution system, laboratory information management system, electronic batch record, supervisory control system, or operator interface.

In further embodiments, controller 200 stores the chromatographic-spectral data set and associated control actions for traceability. The stored record can include raw spectra, corrected spectra, chromatography data, mobile-phase data, model version, calibration-library version, sample identifier, batch identifier, fraction identifier, control decisions, operator overrides, and system suitability results. Such records can support method development, process monitoring, quality control, deviation investigation, lot release, or regulatory documentation.

Any control of fraction collection, valve switching, pooling, diversion, or downstream processing is optional. In many embodiments, controller 200 performs an analytical function only, such as identifying, confirming, characterizing, or quantifying constituents in the chromatographic eluate, without controlling a fraction collector or other process device. In embodiments where process control is provided, the control action is a possible use of the analytical result and is not required for the combined LC-NIR workflow. The broader workflow is therefore directed to association of chromatographic separation information with NIR spectral information to generate improved analyte identity, compositional, and quantitative information.

Collectively, these advancements in optical-based detection technologies, particularly when integrated with advanced NIR spectroscopy in SEC applications, have significantly enhanced the capability of HPLC systems to provide rapid, sensitive, and precise analytical results, thereby reinforcing their critical role in biopharmaceutical and life sciences industries.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for analyzing a sample, comprising:
introducing the sample into a liquid chromatography system;
separating constituents of the sample by the liquid chromatography system to produce an eluate comprising temporally separated constituents;
directing at least a portion of the eluate through a flow cell of a near-infrared spectroscopic detector, the flow cell defining a sample detection region;
interrogating the sample detection region with optical radiation comprising one or more wavelengths in a near-infrared spectral region;
detecting optical radiation that has interacted with the eluate in the sample detection region;
generating near-infrared spectral data for the eluate;
associating the near-infrared spectral data with a chromatographic coordinate of the liquid chromatography system; and
identifying or quantifying at least one constituent of the sample based on the near-infrared spectral data and the chromatographic coordinate.

2. The method of claim 1, wherein the chromatographic coordinate comprises at least one of a retention time, an elution volume, a fraction number, a column volume, or a chromatographic peak.

3. The method of claim 1, wherein the liquid chromatography system is operated in a chromatography mode selected from size exclusion chromatography, ion exchange chromatography, reversed-phase chromatography, hydrophobic interaction chromatography, affinity chromatography, mixed-mode chromatography, hydrophilic interaction chromatography, normal-phase chromatography, and combinations thereof.

4. The method of claim 1, wherein generating the near-infrared spectral data comprises comparing the detected optical radiation with a reference signal to compensate for optical power variation during the interrogation.

5. The method of claim 1, wherein the optical radiation is generated by a tunable laser that sweeps across a spectral band.

6. The method of claim 5, wherein the spectral band is within a range of about 780 nm to about 2500 nm, about 1350 nm to about 1800 nm, or about 2050 nm to about 2400 nm.

7. The method of claim 1, wherein identifying or quantifying the at least one constituent comprises comparing the near-infrared spectral data with at least one of a calibration library, a spectral library, a chemometric model, a classification model, or a regression model.

8. The method of claim 1, further comprising receiving a signal from at least one additional detector or sensor associated with the liquid chromatography system or the flow cell, and using the signal with the near-infrared spectral data.

9. The method of claim 8, wherein the signal comprises at least one of ultraviolet absorbance, visible absorbance, diode-array absorbance, fluorescence, refractive index, conductivity, pH, pressure, flow rate, temperature, gradient composition, or fraction-collector status.

10. The method of claim 1, wherein the liquid chromatography system is operated in size exclusion chromatography mode, and wherein identifying or quantifying the at least one constituent comprises distinguishing a monomeric biomolecule from an aggregate or high-molecular-weight species.

11. The method of claim 10, wherein the biomolecule comprises a protein, antibody, monoclonal antibody, peptide, oligonucleotide, enzyme, or vaccine component.

12. The method of claim 1, further comprising outputting an analytical result and using the analytical result to control at least one of the liquid chromatography system, a valve, a fraction collector, a flow rate, a gradient, a stopped-flow acquisition, fraction pooling, fraction rejection, or a bioprocess operation.

13. A method for monitoring a bioprocess, comprising:
obtaining a sample from a bioprocess vessel, process line, harvest stream, formulation vessel, or autosampler;
separating constituents of the sample by liquid chromatography;
flowing eluate from the liquid chromatography through a near-infrared spectroscopic flow cell;
acquiring near-infrared spectra from the eluate during or after the chromatographic separation;
determining a process-related attribute of the sample from the near-infrared spectra; and
outputting the process-related attribute for use in monitoring or controlling the bioprocess.

14. An analytical system comprising:
a liquid chromatography system configured to separate constituents of a sample and produce an eluate;
a near-infrared spectroscopic detector in fluid communication with the liquid chromatography system, the near-infrared spectroscopic detector comprising:
a flow cell defining a sample detection region configured to receive at least a portion of the eluate;
a light source configured to direct optical radiation comprising one or more near-infrared wavelengths through the sample detection region; and
a sample detector configured to detect optical radiation that has interacted with the eluate in the sample detection region; and
a controller configured to generate near-infrared spectral data from a signal of the sample detector and to identify or quantify at least one constituent of the sample based on the near-infrared spectral data and chromatographic separation information from the liquid chromatography system.

15. The analytical system of claim 14, wherein the liquid chromatography system is configured to perform at least one of size exclusion chromatography, ion exchange chromatography, reversed-phase chromatography, hydrophobic interaction chromatography, affinity chromatography, mixed-mode chromatography, hydrophilic interaction chromatography, or normal-phase chromatography.

16. The analytical system of claim 14, wherein the liquid chromatography system comprises a high-performance liquid chromatography system or an ultra-high-performance liquid chromatography system.

17. The analytical system of claim 14, wherein the light source comprises a tunable semiconductor laser.

18. The analytical system of claim 17, wherein the tunable semiconductor laser is configured to sweep through a spectral band within about 780 nm to about 2500 nm, about 1350 nm to about 1800 nm, or about 2050 nm to about 2400 nm.

19. The analytical system of claim 14, wherein the near-infrared spectroscopic detector further comprises a beam splitter and a reference photodetector configured to detect a reference beam split from the optical radiation.

20. The analytical system of claim 14, wherein the controller is configured to generate a chromatographic-spectral data set comprising near-infrared spectral data indexed to at least one of retention time, elution volume, fraction number, column volume, or chromatographic peak.

21. The analytical system of claim 14, wherein the controller is configured to compare the near-infrared spectral data with at least one of a calibration library, a spectral library, a chemometric model, a classification model, or a regression model.

22. The analytical system of claim 14:
wherein the controller is configured to distinguish a monomeric biomolecule from an aggregate or high-molecular-weight species after size exclusion chromatography or
wherein the controller is configured to identify or quantify at least one of a charge variant, hydrophobic variant, conformational variant, post-translationally modified form, impurity, degradation product, or contaminant or
wherein the flow cell comprises an input optical element and an output optical element that define the sample detection region therebetween.
